(19) United States
(12) Patent Application Publication
(10) Pub. No.: US 2012/0132495 A1
(43) Pub. Date: May 31, 2012

(54) STOP OF SLIDE FOR TRANSMISSION STRUCTURE

(76) Inventor: SHIH-CHOU WEN, Sanchong City (TW)

(21) Appl. No.: 12/955,906

(22) Filed: Nov. 30, 2010

(51) Int. Cl. F16D 15/00; F16D 43/02; F16D 13/20

(52) U.S. Cl. 192/45.1; 192/109 R

(57) ABSTRACT

Disclosed is a stop of slide for transmission structure, which includes an input shaft and a centrifugal saddle movable with respect to the input shaft. The centrifugal saddle includes a driving disc that forms slots. Slides are received in a slide channel of an output shaft and a channel of a casing. Each slide has a side movably received in the slots. The slide forms at least one notch that has a slope section forming a rounded corner and receiving a roll positioned thereon. The roll is biased by an elastic biasing element to move toward the rounded corner. The notch is provided with a stop member, which helps stopping the roll and resisting a force induced by the roll so as to protect the elastic biasing element from being excessively compressed and thus damaged by the roll.

### TECHNICAL FIELD OF THE INVENTION

The present invention generally relates to the field of variable transmission, and more particularly to a stop of a slide for transmission structure that is of a simple structure and effective in protecting a clutch component from being undesirably damaged.

### DESCRIPTION OF THE PRIOR ART

The present inventor has been issued with a number of patents regarding to continuous variable transmission. An example is shown in Taiwan Utility Model Publication No. M315279, wherein a main transmission shaft uses a frictional engagement force of a slide to drive a clutch wheel to rotate. The slide is arranged in a slide slot defined in the clutch wheel so that when the slide moves in the slide slot, a surface of a roll and the slide slot induce therebetween a frictional engagement force that drives the clutch wheel to rotate. However, when the slide received in the slide slot does not drive the rotation of the clutch wheel but the clutch wheel is kept in a rotating condition, the slide slot causes the roll to move in a direction toward a spring due to the frictional force, making the spring excessively compressed by the roll and thus damaged. It is thus desired to protect the clutch component of the continuous variable transmission from being damaged, which is goal of the present invention.

### SUMMARY OF THE INVENTION

An objective of the present invention is to provide a stop of slide for transmission structure that helps protecting a clutch component from being undesirably damaged and improving the service life thereof Structurally, the present invention comprises an automatic transmission eccentric shaft device, a driving disc, an output shaft, and a plurality of slides. Each of the slides forms at least one notch. The notch comprises a slope section. The slope section forms a rounded corner and comprises a roll positioned thereon. The roll is biased by an elastic biasing element to move in a direction toward the rounded comer. The notch is provided with a stop member. A frictional engagement force can be induced by the roll to drive the output shaft or the casing to rotate. When the roll is acted upon by a force to move in a direction away from the rounded corner, the stop member stops the roll and resists a force caused by the roll so as to protect the elastic biasing element from being excessively compressed and thus damaged by the roll.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view of the present invention.

FIG. 2 is an exploded view of the present invention.

FIG. 3 is an exploded view of the slides and a slide channel according to the present invention.

FIG. 4 is a perspective view showing the slides and the slide channel according to the present invention in an assembled form.

FIG. 5 is a cross-sectional view showing an automatic transmission eccentric shaft device according to the present invention.

FIG. 6 is a cross-sectional view demonstrating an operation of the automatic transmission eccentric shaft device according to the present invention.

FIG. 7 is a cross-sectional view demonstrating a driving disc becoming eccentric according to the present invention.

FIG. 8 is a schematic view illustrating the slides driving an output shaft according to the present invention.

FIG. 9 is a schematic view illustrating a stop member stopping movement of rolls according to the present invention.

FIG. 10 is a perspective view showing a curved plate included stop member according to the present invention.

FIG. 11 is a plan view of FIG. 10 in an assembled form.

FIG. 12 is a perspective view showing a fitting block included stop member according to the present invention.

FIG. 13 is a plan view of FIG. 12 in an assembled form.

FIG. 14 shows a perspective view of a stop bar included stop member and a plan view thereof in an assembled form.

FIG. 15 is an exploded view showing an example that a stop member is integrally formed with a slide according to the present invention.

FIG. 16 is a plan view of FIG. 15 in an assembled form.

FIG. 17 is a cross-sectional view showing an embodiment of the present invention that further comprises an arrestment device.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

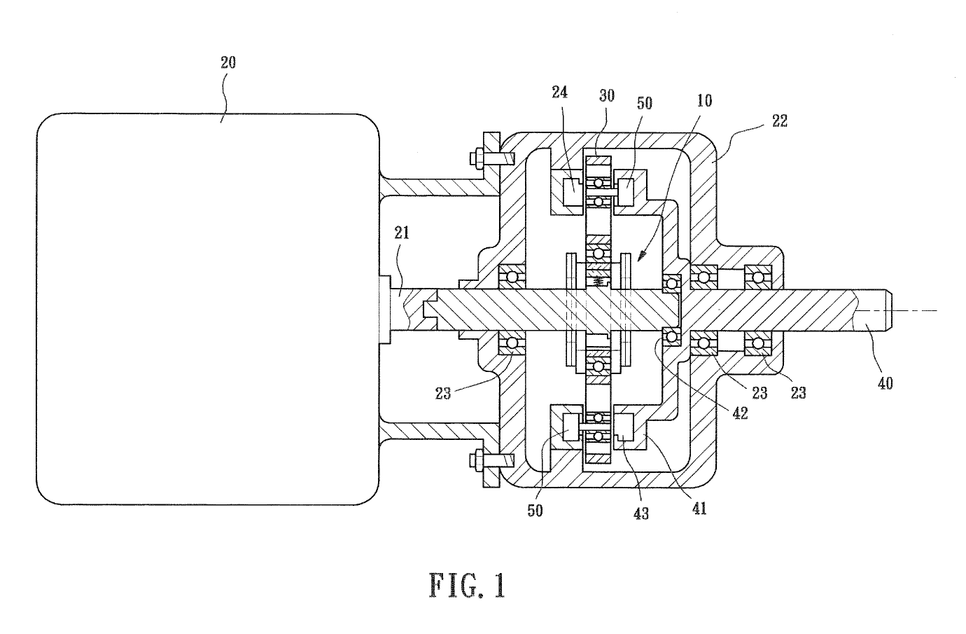

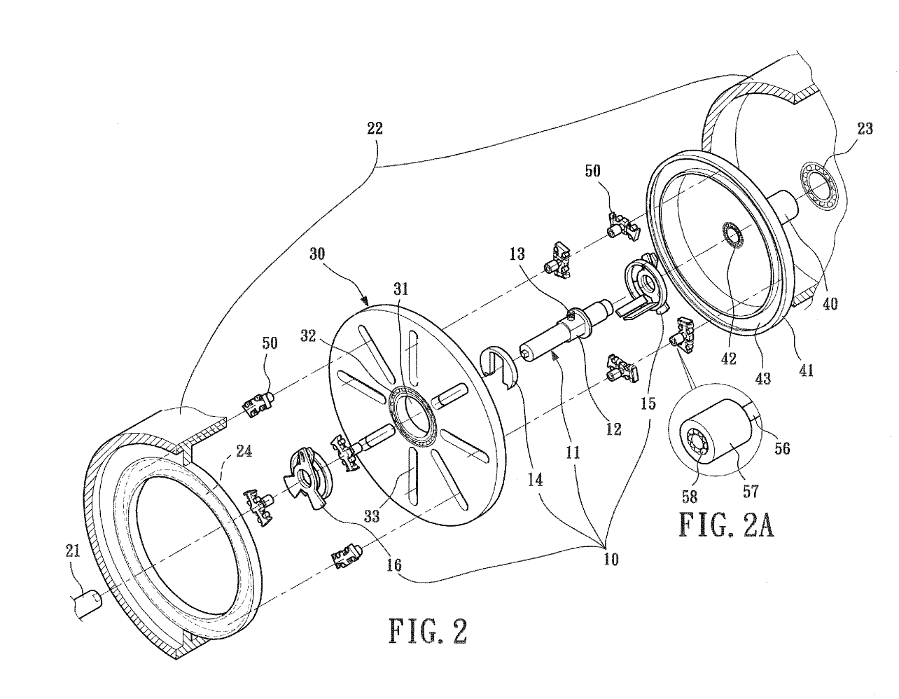

Referring to FIGS. 1 and 2, an embodiment of the present invention comprises an automatic transmission eccentric shaft device 10, a prime mover 20, a driving disc 30, an output shaft 40, and a plurality of slides 50. These components will be described as follows:

The automatic transmission eccentric shaft device 10 is of a conventional structure and will be briefly described for the understanding of the present invention. The automatic transmission eccentric shaft device 10 comprises an input shaft 11 that is driven by the prime mover 20 for rotation. The input shaft 11 forms a seat 12 thereon. The seat 12 comprises an elastic body 13 mounted thereon and forms two flat flanks on opposite sides thereof to receive a centrifugal saddle 14 fit thereon to be movable up and down (in the direction shown in FIGS. 1 and 2) with respect to the seat 12 as being guided by the flat flanks. Mounted on the seat 12 and the input shaft 11 are two weight assemblies 15, 16. When the input shaft 11 rotates, a centrifugal force is induced to cause radial displacements of the weight assemblies 15, 16, which in turn drive the centrifugal saddle 14 to move up and down with respect to the seat 12.

The prime mover 20 can be a motor or an engine. The prime mover 20 comprises a driving shaft 21, which is coupled to the input shaft 11 for rotating the input shaft 11. The prime mover 20 comprises a casing 22, which houses the automatic transmission eccentric shaft device 10, the driving disc 30, the output shaft 40, and the slides 50, and comprises a plurality of bearings 23 for supporting stable rotation of the input shaft 11 and the output shaft 40.

The driving disc 30 forms a plurality of radially extending slots 33, and also forms, in a center thereof, a through hole 31 that receives and retains therein a bearing 32, which is fit over the centrifugal saddle 14.

The output shaft 40 comprises a clutch disc 41. The clutch disc 41 comprises a bearing 42 arranged at a location coaxially corresponding to the output shaft 40 so that the bearing 42 can be fit over an end of the input shaft 11 for supporting stable rotation thereof. The clutch disc 41 has a circumferential rim forming a slide channel 43.

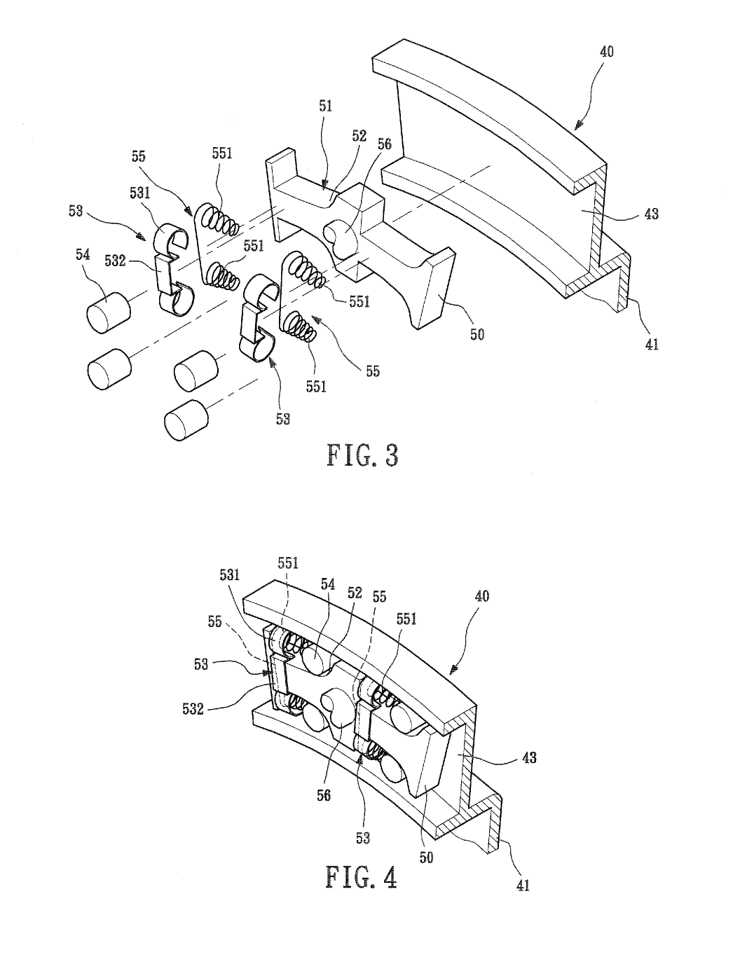

The slides 50 (also see FIGS. 3, 4, and 9) are respectively received in the slots 33 in an alternate manner, so that the slides 50 that project beyond the surface of the driving disc 30 opposing the clutch disc 41 are slidably received in the slide channel 43, while the slides 50 that project beyond an opposite surface of the driving disc 30 are slidably received in a circumferential channel 24 defined in an inside wall of the casing 22. Each of the slides 50 forms a plurality of notches 51, and in the instant embodiment, the slide 50 comprises two such notches 51 formed in each of top and bottom of the slide. Each of the notches 51 comprises a slope section 52 and a stop member 53, wherein the slope section 52 forms a rounded corner and a roll 54 is received therein. The roll 54 is biased by an elastic biasing element 55 set in the notch 51 to move toward the rounded corner. As such, a surface of the roll 54 and the slide channel 43 form a frictional engagement force therebetween. In the instant embodiment, the stop member 53 comprises two curved stop plates 531, which are connected to each other by a U-shaped connection plate 532 arranged therebetween. The connection plate 532 can be fit to and retained on the slide 50 between two notches without being detached easily, so as to set the stop plates 531 in the notches 51 of the top and bottom of the slide. The elastic biasing element 55 has a biasing portion 551 acting on the roll and the biasing portion has a root section that is enclosed by the corresponding the stop plate 531, so that the stop plate 531 can stop a movement of the roll 54 heading toward the stop plate, as shown in FIG. 9. In other words, when the roll 54 is forced to move in the notch 51 in a direction away from the rounded corner (namely heading toward the stop plate), the stop member 53 (namely the stop plate 531) may engage and thus stop the movement of the roll 54 and resist a force caused by the roll to protect the elastic biasing element 55 from being excessively compressed and thus broken. Each of the slides 50 comprises a bar 56 projecting from one side thereof and the bar 56 carries a roller 57 thereon. A bearing 58 is arranged between the bar 56 and the roller 57 to support relative rotation therebetween, so as to facilitate the rotation of the roller 57 and thus reduce the frictional force between the roller 57 and the slot 33.

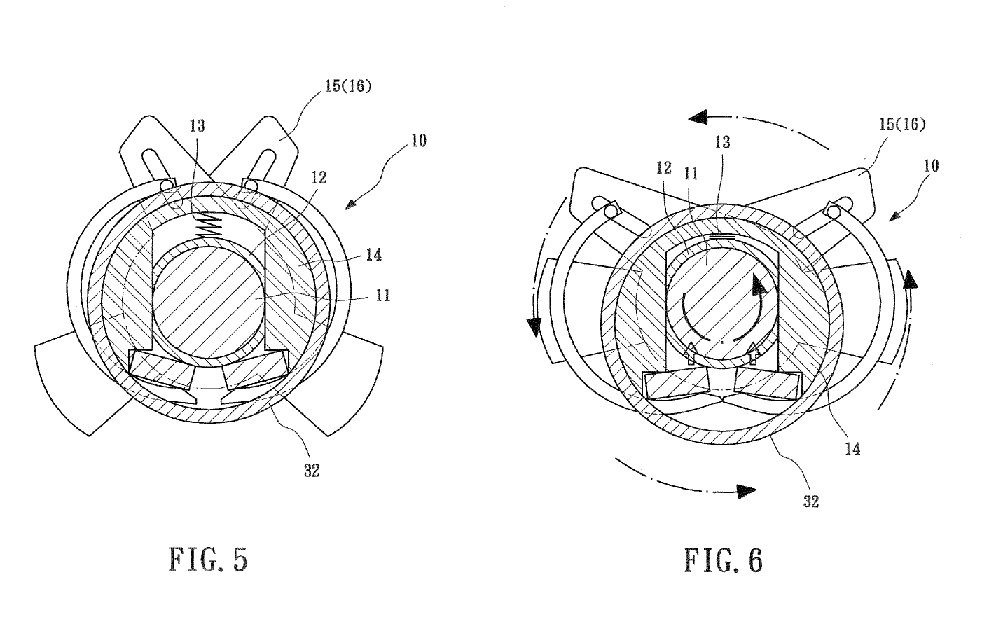

Referring to FIGS. 5 and 6, the input shaft 11 is driven by the prime mover 20 to rotate. When the input shaft 11 rotates, a centrifugal force is induced to cause radial displacements of the weight assemblies 15, 16, which in turn depress the centrifugal saddle 14 downward (in the direction shown in FIGS. 5 and 6), whereby the centrifugal saddle 14 and the bearing 32 are moved downward with respect to the seat 12 to assume an eccentric condition, also causing the driving disc 30 to displace downward by a predetermined distance to assume an eccentric condition for realizing continuous variable transmission.

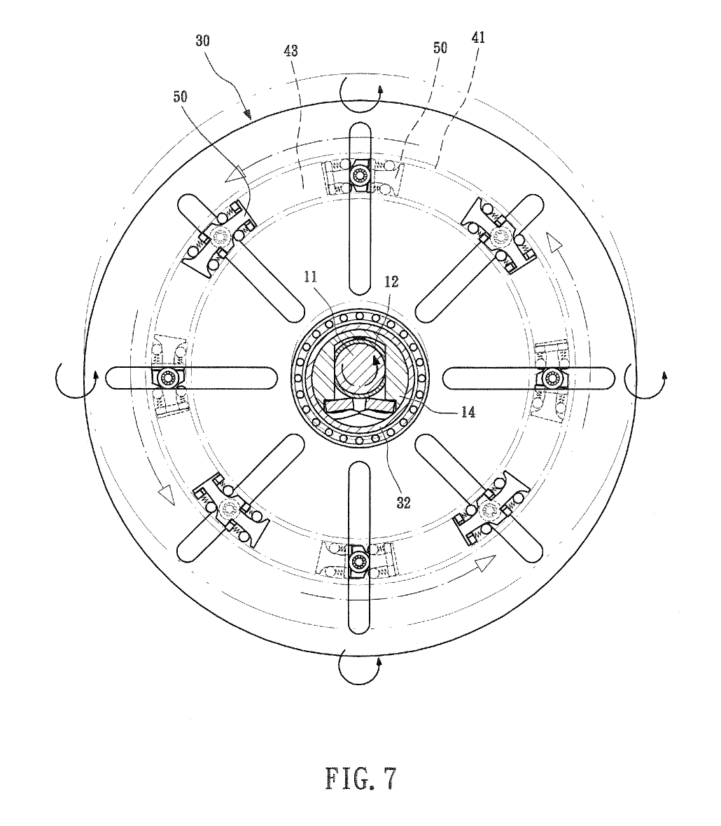

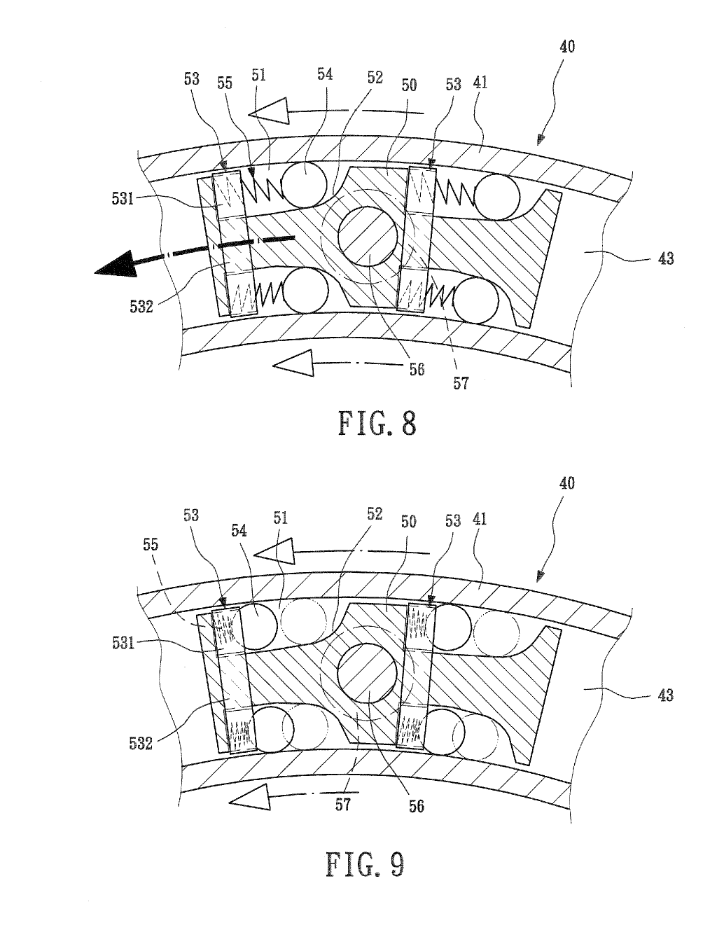

Referring to FIGS. 7 and 8, increased rotation of the input shaft 11 causes the driving disc 30 to rotate in an eccentric condition and makes the slides 50 sliding along the slide channel 43. Under this condition, the rolls 54 are set in tight engagement with the slide channel 43 by the biasing forces of the elastic biasing elements 55 so that the frictional engagement force induced between the surfaces of the rolls 54 and the slide channel 43 drives the output shaft 40 to rotate. Thus, through the combination of the automatic transmission eccentric shaft device 10, the prime mover 20, the driving disc 30, the output shaft 40, and the slides 50, the whole structure of the present invention is simple and the manufacturing cost is reduced and further advantages of high rotational speed and high torque can be realized.

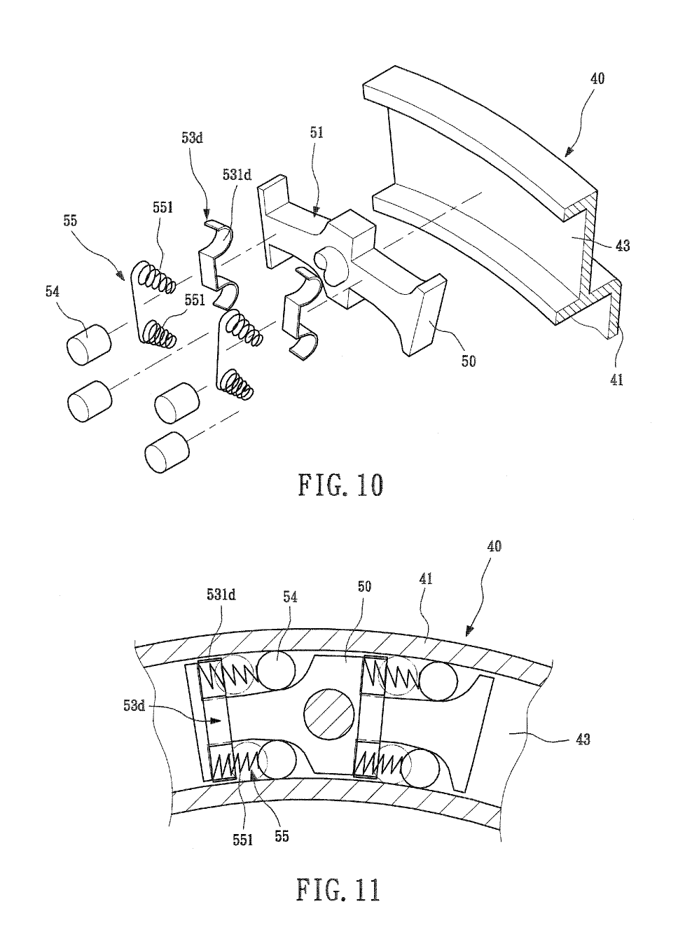

Referring to FIGS. 10 and 11, a structure of stop member according to a second embodiment of the present invention is provided, wherein the stop member 53d comprises two C-shaped curved plates 531d that are spaced from each other by a distance and are connected to each other. A connection between the curved plates 531d is fit to the slide 50 to have the curved plates 531d respectively positioned in the notches 51. Further, the elastic biasing element 55 associated with each curved plate has biasing portion 551 of which a root is properly enclosed by the curved plate 531d so that the curved plate 531d may function to stop excessive movement of the roll 54.

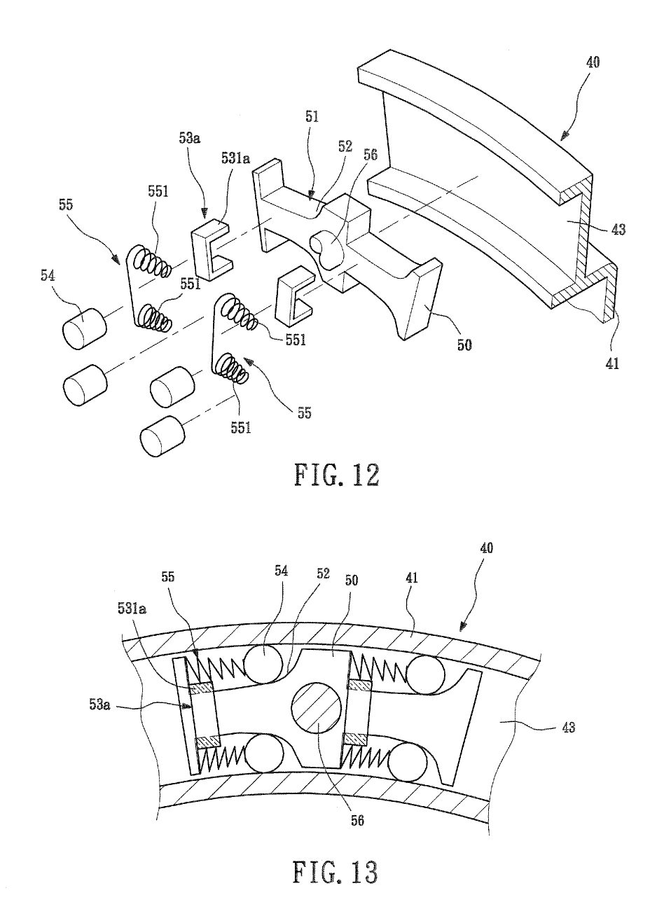

Referring to FIGS. 12 and 13, a structure of stop member according to a third embodiment of the present invention is provided, wherein the stop member 53a has a U-shaped configuration, and the stop member 53a comprises two fitting blocks 531a that are spaced from each other by a distance and are connected to each other. A connection between the fitting blocks 531a is fit to the slide 50 to have the fitting blocks 531a positioned in the notches 51, so that the fitting blocks 531a may function to stop excessive movement of the roll 54.

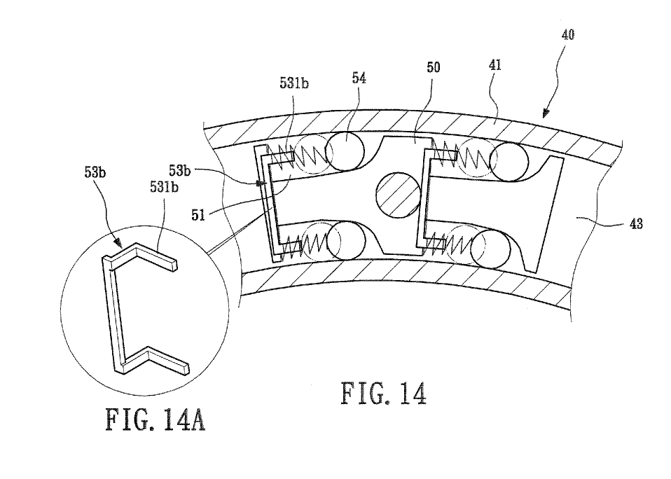

Referring to FIG. 14, a structure of stop member according to a fourth embodiment of the present invention is provided, wherein the stop member 53b comprises a substantially U-shaped frame and the stop member 53b comprises two L-shaped stop bars 531b that are spaced from each other by a distance and are connected to each other. A connection between the stop bars 531b is fit to the slide 50 to have the stop bars 531b positioned in the notches 51, so that the stop bars 531b may function to stop excessive movement of the roll 54.

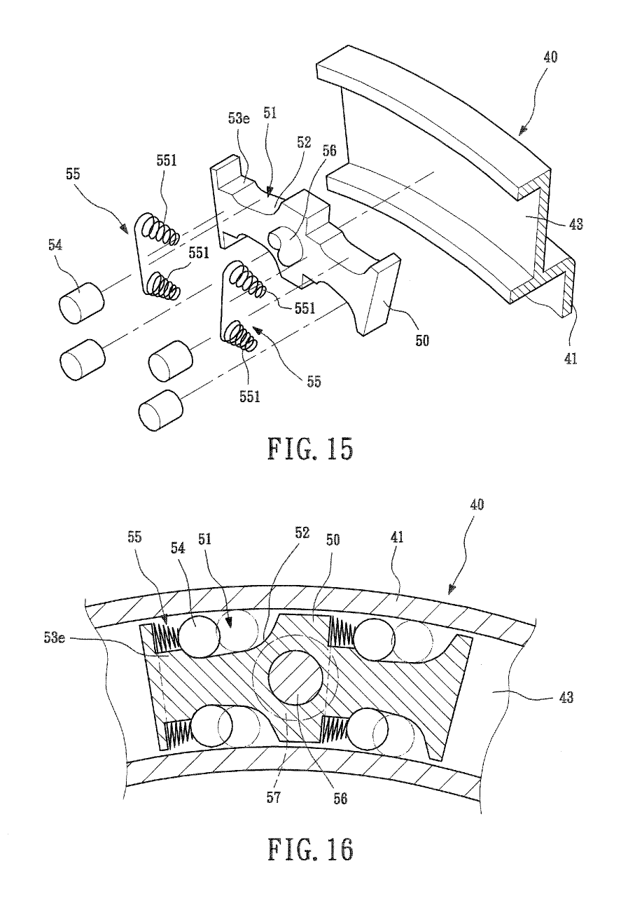

Referring to FIGS. 15 and 16, a structure of stop member according to a sixth embodiment of the present invention is provided, wherein the stop member 53e is integrally formed in the notches 51.

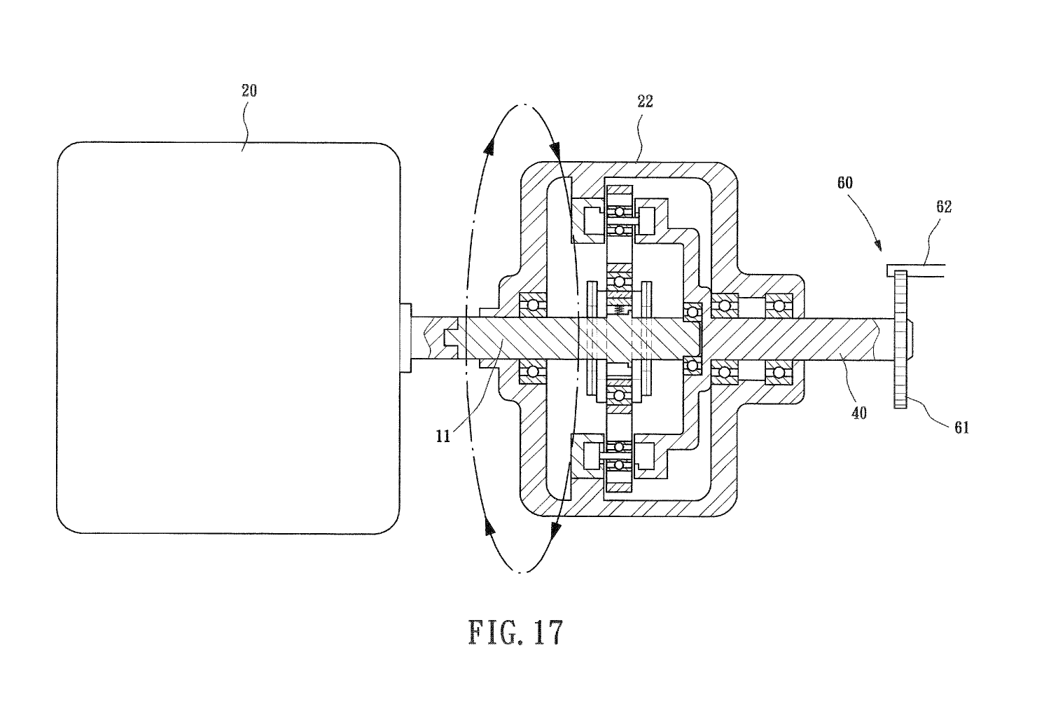

Referring to FIG. 17, the present invention may further comprise an arrestment device 60 mounted on the output shaft 40. The arrestment device 60 comprises a ratchet wheel 61 mounted to the output shaft 40 and a pawl 62 engageable with the ratchet wheel 61, whereby a user may use the arrestment device 60 to set the output shaft 40 as a stationary shaft and make the casing 22 rotating with respect to the stationary output shaft 40.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A stop of slide for transmission structure, comprising:
an automatic transmission eccentric shaft device, which is adapted to receive a power input from a prime mover for rotation, the automatic transmission eccentric shaft device comprising an input shaft and a centrifugal saddle that is movable with respect to the input shaft when the input shaft is rotating;
a driving disc, which is coupled to the centrifugal saddle, the driving disc forming at least one slot;
an output shaft, which comprises a clutch disc having a surface forming a slide channel;
a casing, which has an inside wall forming a channel; and
a plurality of slides, which is respectively received in the slide channel and the channel, each of the slides forming at least one notch, which comprises a slope section, the slope section forming a rounded corner and receiving a roll positioned thereon, the roll being biased by an elastic biasing element to move in a direction toward the rounded corner, each of the slides having a side forming a bar, which carries a roller thereon, so that the slide is movably received in the slot by means of the roller;
characterized in that the notch comprises a stop member;
wherein a frictional engagement force is induced by the roll to drive the output shaft or the casing to rotate, and when the roll is acted upon by a force to move in a direction away from the rounded corner, the stop member stops the roll and resists a force caused by the roll so as to protect the elastic biasing element from being excessively compressed and thus damaged.

2. The stop of slide for transmission structure according to claim 1, wherein the stop member comprises two fitting blocks that are spaced from each other by a distance and are connected to each other by a connection that is provided between the fitting blocks and fit to the respective slide to have the fitting blocks respectively positioned in the notches defined in the slide, so that the fitting blocks stop the roll.

3. The stop of slide for transmission structure according to claim 1, wherein the stop member comprises two stop bars that are spaced from each other by a distance and are connected to each other by a connection that is provided between the stop bars and fit to the respective slide to have the stop bars respectively positioned in the notches defined in the slide, so that the stop bars stop the roll.

4. The stop of slide for transmission structure according to claim 1, wherein the stop member comprises two curved plates that are spaced from each other by a distance and are connected to each other by a connection that is provided between the curved plates and fit to the respective slide to have the curved plates respectively positioned in the notches defined in the slide, so that the curved plates stop the roll.

5. The stop of slide for transmission structure according to claim 1, wherein the stop member comprises two curved stop plates that are spaced from each other by a distance and are connected to each other by a connection plate, the connection plate being fit to the respective slide to have the stop plates respectively positioned in the notches defined in the slide, the elastic biasing element having a root that is enclosed by the respective stop plate, so that the stop plate stops the roll.

6. The stop of slide for transmission structure according to claim 1, wherein the stop member is integrally formed with the notches of the respective slide.
